(19) United States
(12) Patent Application Publication
(10) Pub. No.: US 2023/0186155 A1
(43) Pub. Date: Jun. 15, 2023

(54) MACHINE LEARNING METHOD AND INFORMATION PROCESSING DEVICE

(71) Applicant: Fujitsu Limited, Kawasaki-shi (JP)

(72) Inventor: Akihiko KASAGI, kawasaki (JP)

(73) Assignee: Fujitsu Limited, Kawasaki-shi (JP)

(21) Appl. No.: 17/903,044

(22) Filed: Sep. 6, 2022

(30) Foreign Application Priority Data
Dec. 15, 2021 (JP) 2021-203439

(51) Int. Cl. G06N 20/00; G06K 9/62

(52) U.S. Cl. CPC G06N 20/00; G06K 9/6256

(57) ABSTRACT

A non-transitory computer-readable recording medium stores a program for causing a computer to execute a process, the process includes inputting training data to a machine learning model that includes a generator and a discriminator, the generator generating second input data in which a part of first input data is rewritten in response to an input of the first input data, the discriminator discriminating a rewritten portion in response to an input of the second input data generated by the generator, generating correct answer information, based on the training data and an output result of the generator, and executing training of the machine learning model by using first error information obtained based on the output result of the generator and a discrimination result of the discriminator, and second error information obtained based on the discrimination result of the discriminator and the correct answer information.

### CROSS-REFERENCE TO RELATED APPLICATION

This application is based upon and claims the benefit of priority of the prior Japanese Patent Application No. 2021-203439, filed on Dec. 15, 2021, the entire contents of which are incorporated herein by reference.

### FIELD

The embodiments discussed herein are related to a machine learning method and an information processing device.

### BACKGROUND

In a machine learning model using deep learning in the field of natural language processing, it is common to perform two stages of learning made up of pre-learning and fine tuning.

In the pre-learning, learning such as versatile language learning for word meaning, basic grammar, and the like is executed with a large amount of sentence data as examples. In this pre-learning, unsupervised learning is basically carried out, and a machine learning model is trained with a large amount of data as language pattern samples.

The fine tuning is training that gives a clear task to the machine learning model after the pre-learning by supervised learning, where a neural network capable of reading sentence meaning and the like to some extent because pre-learning has been finished is given a problem and correct answer information and trained so as to solve a specified task. The final accuracy depends on the content of the pre-learning because the learning content at the time of pre-learning has a strong influence on how much the sentence meaning is read.

In order to perform highly accurate learning, pre-learning using a huge amount of data is supposed, but the arithmetic amount is huge. Thus, as a high-speed technique to shorten the processing time, a technique that uses two language processing neural networks, namely, a generator and a discriminator, is known.

For example, the generator is a masked language model (MLM) and executes training of learning in which randomly masked sentences are input and appropriate words and phrases are filled in. The discriminator is for replaced token detection (RTD) and executes training of learning in which sentences learned and filled by the generator are input such that the problem of differentiating which word is different from the original input sentence is solved.

U.S. Patent Application Publication No. 2021/0089724, U.S. Patent Application Publication No. 2020/0019863, and Japanese Laid-open Patent Publication No. 2021-018588 are disclosed as related art.

### SUMMARY

According to the embodiments, a non-transitory computer-readable recording medium stores a program for causing a computer to execute a process, the process includes inputting training data to a machine learning model that includes a generator and a discriminator, the generator generating second input data in which a part of first input data is rewritten in response to an input of the first input data, the discriminator discriminating a rewritten portion in response to an input of the second input data generated by the generator, generating correct answer information, based on the training data and an output result of the generator, and executing training of the machine learning model by using first error information and second error information, the first error information being obtained based on the output result of the generator and a discrimination result of the discriminator, the second error information being obtained based on the discrimination result of the discriminator and the correct answer information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an information processing device according to a first embodiment;

FIG. 2 is a diagram illustrating a functional configuration of the information processing device according to the first embodiment;

FIG. 3 is a diagram illustrating a machine learning model according to the first embodiment;

FIG. 4 is a diagram illustrating pre-learning of the machine learning model according to the first embodiment;

FIG. 5 is a diagram illustrating fine tuning of the machine learning model according to the first embodiment;

FIG. 6 is a flowchart illustrating a flow of a machine learning process according to the first embodiment;

FIGS. 7A and 7B are diagrams illustrating points to be noted in the machine learning process according to the first embodiment;

FIG. 8 is a diagram illustrating pre-learning of a machine learning model according to a second embodiment;

FIG. 9 is a flowchart illustrating a flow of a machine learning process according to the second embodiment; and

FIG. 10 is a diagram illustrating a hardware configuration example.

### DESCRIPTION OF EMBODIMENTS

Although the above-described technique may speed up machine learning, it is difficult to reach the expected accuracy.

For example, the generator (MLM) focuses only on masked characters and selects words that are inferred from the preceding and following sentences and words. For this reason, if the ratio of masked characters is too high, filling in is hardly realized in the first place, and thus commonly, a ratio of about 15% is masked. The discriminator (RTD) determines whether or not masking is applied for all the input words and determines that it is highly likely that the generator has filled in the masks for contextually strange portions. Therefore, the relationship between the preceding and following words and the like also serve as verification criteria, and the contribution of words to learning is 100%, which enables higher-speed processing.

However, it is difficult to reach the expected accuracy because the correct answer rate in filling in the masks rises as the generator learns. For example, since a problem generated by a generator whose correct answer rate has risen increases a ratio of “original” and the discriminator learns that a higher percentage of correct answers is obtained if answering as “original”. Therefore, in the latter half of the learning, the learning efficiency of the discriminator deteriorates.

Hereinafter, embodiments of a machine learning method and an information processing device disclosed in the present application will be described with reference to the drawings. Note that the embodiments are not limited by these embodiments. In addition, the embodiments may be appropriately combined with each other as long as no contradiction occurs.

### First Embodiment

### Description of Information Processing Device

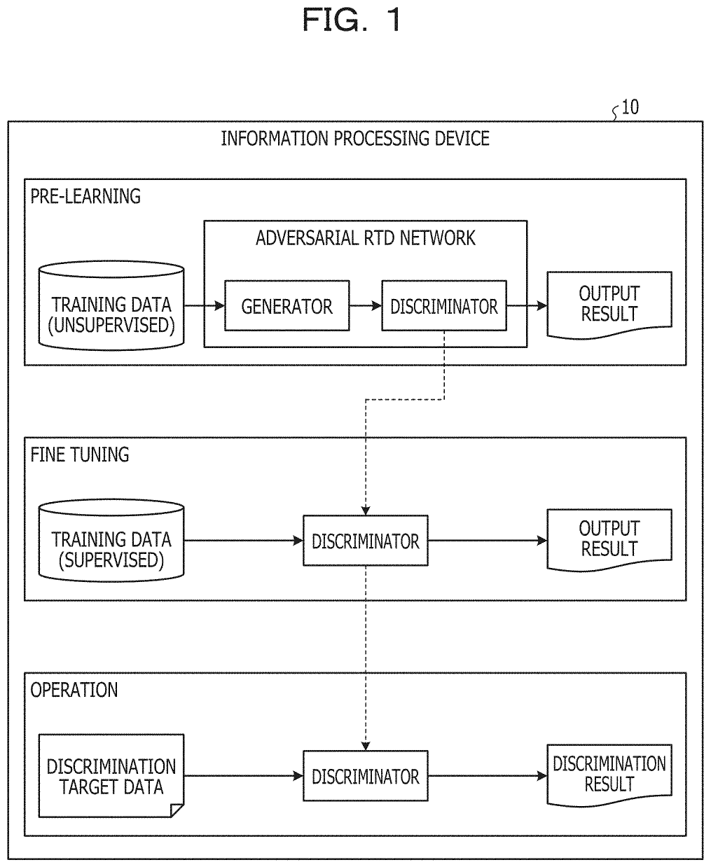

FIG. 1 is a diagram illustrating an information processing device 10 according to a first embodiment. The information processing device 10 is an example of a computer that generates a machine learning model using deep learning in the field of natural language processing and generates a machine learning model by two stages of machine learning made up of pre-learning and fine tuning to execute an operation using the generated machine learning model. Note that, in the present embodiment, an example in which the information processing device 10 executes each phase of pre-learning, fine tuning, and operation will be described, but each phase may be executed by a separate device.

As illustrated in FIG. 1, the machine learning model generated by the information processing device 10 is constituted by an adversarial replaced token detection (RTD) network including a generator and a discriminator. For example, in response to the input of first input data, the generator generates second input data in which a part of the input data is rewritten. The discriminator discriminates the rewritten portion in response to the input of the second input data generated by the generator.

In such a situation, in the pre-learning phase, the information processing device 10 uses unsupervised training data that does not have correct answer information (labels) to execute training of the generator and the discriminator in the adversarial RTD network. For example, the information processing device 10 generates the correct answer information based on the training data and the output result of the generator. Then, the information processing device 10 uses first error information based on the output result of the generator and the discrimination result of the discriminator, and second error information based on the discrimination result of the discriminator and the correct answer information to execute training of the machine learning model.

When such pre-learning is completed, the information processing device 10 executes the fine tuning. For example, the information processing device 10 executes training on the discriminator trained in the pre-learning, using supervised training data that has the correct answer information (labels).

Thereafter, when the fine tuning is completed, the information processing device 10 executes the operation using the discriminator generated by the pre-learning and the fine tuning. For example, the information processing device 10 inputs discrimination target data to the discriminator and evaluates the validity and the like of the discrimination target data based on the discrimination result of the discriminator.

In this manner, the information processing device 10 constructs a generator that generates a problem as an adversarial network in natural language processing and constructs a topology intended to generate a problem that is difficult for the discriminator to discriminate. As a result, the information processing device 10 may generate a highly accurate machine learning model.

### Functional Configuration

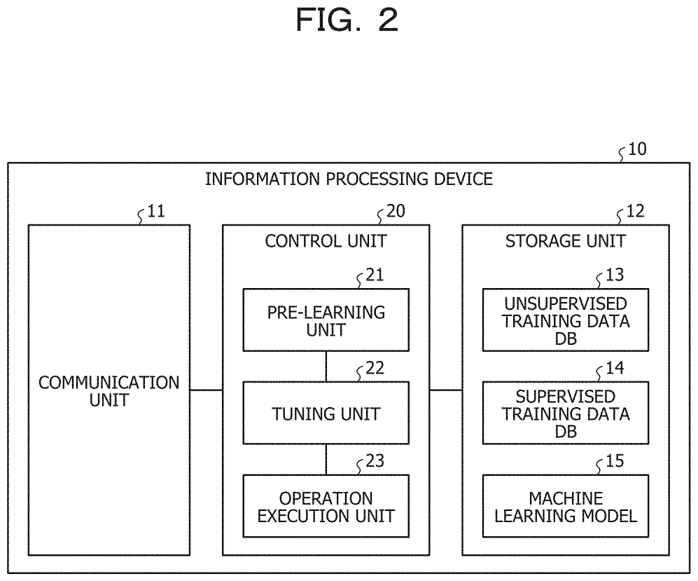

FIG. 2 is a diagram illustrating a functional configuration of the information processing device 10 according to the first embodiment. As illustrated in FIG. 2, the information processing device 10 includes a communication unit 11, a storage unit 12, and a control unit 20.

The communication unit 11 is a processing unit that controls communication with another device and, for example, is implemented by a communication interface or the like. For example, the communication unit 11 executes transmission and reception of various instructions and data with an administrator's terminal.

The storage unit 12 is a processing unit that stores various types of data, various programs executed by the control unit 20, and the like and, for example, is implemented by a memory, a hard disk, or the like. This storage unit 12 stores an unsupervised training data database (DB) 13, a supervised training data DB 14, and a machine learning model 15.

The unsupervised training data DB 13 is a database that stores training data used in the pre-learning, which is unsupervised training data that does not include correct answer information. For example, the unsupervised training data is data used in natural language processing, and for example, is document data containing a plurality of words, such as “A bird flies in the sky”.

The supervised training data DB 14 is a database that stores training data used in the fine tuning, which is supervised training data including the correct answer information. For example, the supervised training data includes document data containing a plurality of words and labels indicating whether each word in the document data is a valid word that is not replaced (original) or a replaced word (replace). Examples of the supervised training data include ‘document data “A bird flies in the sky” and the correct answer information (A: original, bird: original, flies: original, in: original, the: original, sky: original)’, ‘document data “A cat flies in the sky” and the correct answer information (A: original, cat: replace, flies: original, in: original, the: original, sky: original)’, and the like.

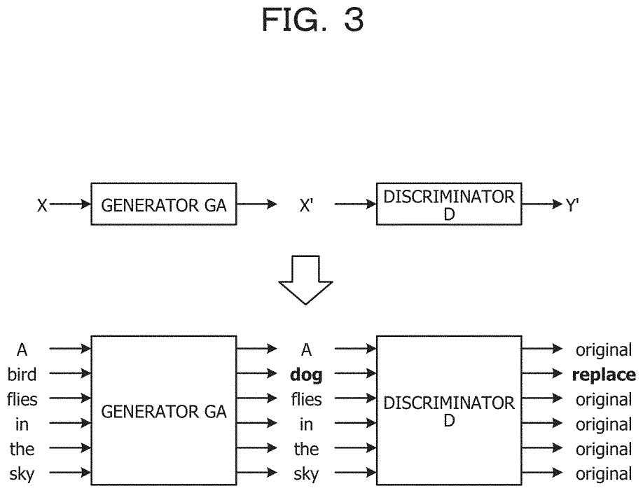

The machine learning model 15 is a model constituted by an adversarial RTD network having a generator and a discriminator. FIG. 3 is a diagram illustrating the machine learning model 15 according to the first embodiment. As illustrated in FIG. 3, the machine learning model 15 includes a generator GA that performs data generation and a discriminator D that executes RTD.

When document data X, which is an example of first document data, is input, the generator GA generates modified document data X′, which is an example of second document data in which at least one word out of a plurality of words contained in the document data X is replaced with another word. When the modified document data X′ is input, the discriminator D outputs a discrimination result Y′ of discrimination as to whether or not each word in the modified document data X′ is a replaced word. Note that a generation process of the generator GA includes the case where a plurality of words is replaced and the case where none of the words is replaced.

For example, when the document data X “A bird flies in the sky” is input, the generator GA generates the modified document data X′ “A dog flies in the sky” by replacing “bird” with “dog” to input the generated modified document data X′ to the discriminator D. The discriminator D outputs the discrimination result Y′ “A: original, dog: replace, flies: original, in: original, the: original, sky: original” indicating whether or not each word in the modified document data X′ “A dog flies in the sky” is replaced.

The control unit 20 is a processing unit that controls the entirety of the information processing device 10 and, for example, is implemented by a processor or the like. This control unit 20 includes a pre-learning unit 21, a tuning unit 22, and an operation execution unit 23. Note that the pre-learning unit 21, the tuning unit 22, and the operation execution unit 23 are implemented by an electronic circuit included in the processor, a process executed by the processor, or the like.

The pre-learning unit 21 is a processing unit that executes training of the pre-learning of the machine learning model 15. For example, the pre-learning unit 21 executes training of the generator GA and the discriminator D using each piece of the unsupervised training data stored in the unsupervised training data DB 13.

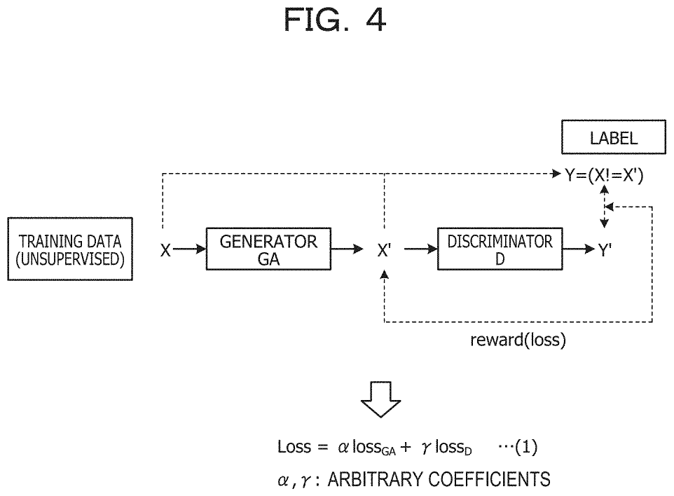

FIG. 4 is a diagram illustrating the pre-learning of the machine learning model 15 according to the first embodiment. As illustrated in FIG. 4, the pre-learning unit 21 inputs the document data X, which is unsupervised training data, to the generator GA and acquires the modified document data X′ generated by the generator GA. Here, the pre-learning unit 21 compares each word in the document data X with each word in the modified document data X′ and generates a label Y (correct answer information) indicating which word is a word that has not been replaced (original) and which word is a word that has been replaced (replace). For example, when the modified document data X′ “A dog flies in the sky” is generated by the generator GA with respect to the document data X “A bird flies in the sky”, the pre-learning unit 21 generates the label Y “A: original, dog: replace, flies: original, in: original, the: original, sky: original”.

Subsequently, the pre-learning unit 21 inputs the modified document data X′ to the discriminator D and acquires the discrimination result Y′ of the discriminator D. Then, the pre-learning unit 21 uses the pass or fail by the discriminator D as a reward in the loss calculation of the modified document data X′ and calculates an error by verifying that loss is large when the discriminator D gives a correct answer and that loss is small when the discriminator D makes a mistake. For example, the pre-learning unit 21 executes training of adversarial learning.

For example, the pre-learning unit 21 executes training of the machine learning model 15 using the first error information which is acquired based on the output result X′ of the generator GA and the discrimination result Y′ of the discriminator D, and the second error information which is acquired based on the discrimination result Y′ of the discriminator D and correct answer information Y. Here, the pre-learning unit 21 generates “loss_{GA}” as the first error information, using a loss function for training the generator GA such that the modified document data X′ is not discriminated by the discriminator D. In addition, the pre-learning unit 21 generates “loss_{D}” as the second error information, using a loss function for training the discriminator D such that the error between the discrimination result Y′ and the correct answer information Y becomes smaller. Then, the pre-learning unit 21 calculates a loss “Loss” of the entire machine learning model 15 as “Loss=αloss_{GA}+γloss_{D}” as indicated by formula (1) in FIG. 4 and executes training to, for example, update various parameters of the generator GA and the discriminator D such that this “Loss” is minimized. Note that α and γ denote arbitrary coefficients.

The tuning unit 22 is a processing unit that executes the fine tuning after the pre-learning by the pre-learning unit 21. For example, the tuning unit 22 executes training of supervised learning of the discriminator D after the pre-learning, using each piece of the supervised training data stored in the supervised training data DB 14.

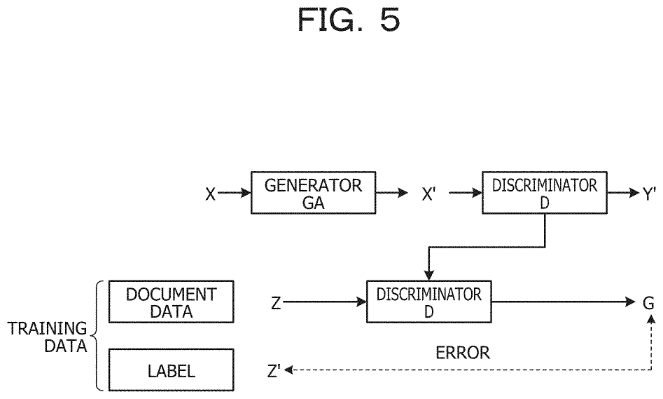

FIG. 5 is a diagram illustrating the fine tuning of the machine learning model 15 according to the first embodiment. As illustrated in FIG. 5, the tuning unit 22 inputs the supervised training data including document data Z and a label Z′ to the discriminator D and acquires a discrimination result G of the discriminator D. Then, the tuning unit 22 executes training to update various parameters and the like of the discriminator D such that the error between the label Z′ and the discrimination result G is minimized.

The operation execution unit 23 is a processing unit that executes an operation process using the discriminator D of the machine learning model 15 generated by the pre-learning and the fine tuning. For example, the operation execution unit 23 inputs the discrimination target data, which is a sentence containing a plurality of words, to the discriminator D and acquires a discrimination result by the discriminator D. Here, the discriminator D discriminates whether or not each word in the discrimination target data is a replaced word. Then, when “replace” exists in the discrimination result, the operation execution unit 23 determines that the discrimination target data is invalid data that is highly likely to have been altered, and outputs an alarm or the like.

For example, the operation execution unit 23 inputs a received mail to the discriminator D and discriminates whether or not the mail is an invalid mail. Note that the discriminator D may be applied not only to discriminate whether or not invalid data is involved, but also to, for example, discriminate whether or not an unnatural word (such as a typographical error) is contained. For example, the operation execution unit 23 may also input generated document data to the discriminator D to acquire the discrimination result and determine that the word corresponding to “replace” in the discrimination result is a misspelling or the like.

### Flow of Process

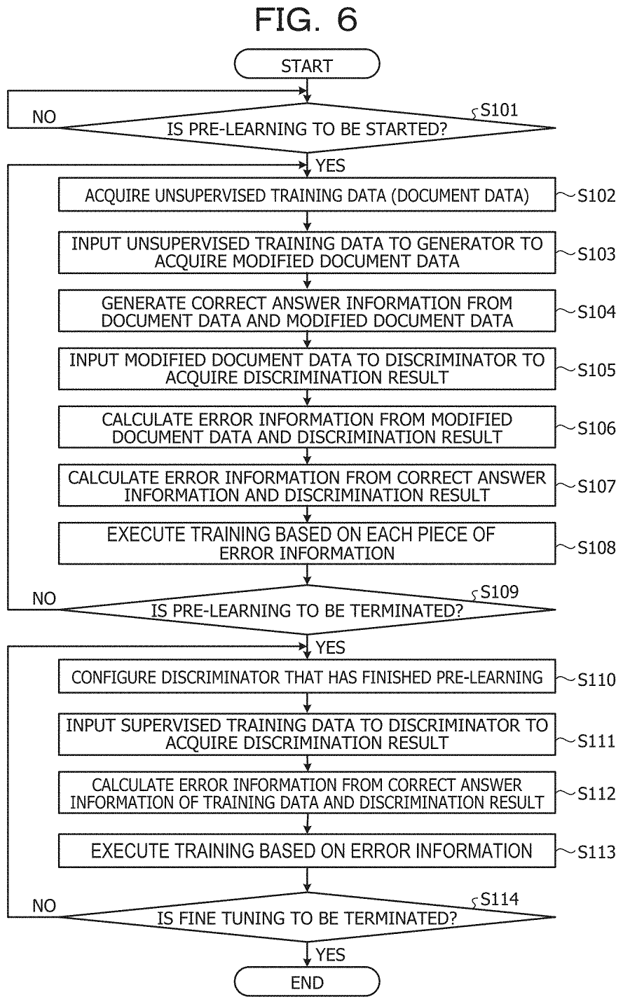

FIG. 6 is a flowchart illustrating a flow of a machine learning process according to the first embodiment. As illustrated in FIG. 6, when the pre-learning is started (S101: Yes), the pre-learning unit 21 acquires unsupervised training data (document data) (S102) and inputs the unsupervised training data to the generator GA to acquire the modified document data (S103).

Subsequently, the pre-learning unit 21 generates the correct answer information from the document data and the modified document data (S104). Then, the pre-learning unit 21 inputs the modified document data to the discriminator D to acquire the discrimination result (S105).

Thereafter, the pre-learning unit 21 calculates error information from the modified document data and the discrimination result (S106), calculates error information from the correct answer information and the discrimination result (S107), and executes training based on each piece of the error information (S108).

Here, when the pre-learning is to be continued (S109: No), the pre-learning unit 21 repeats S102 and the subsequent processes.

On the other hand, when the pre-learning is to be terminated (S109: Yes), the tuning unit 22 configures the discriminator D using the parameters and the like of the discriminator D that has finished the pre-learning (S110) and inputs the supervised training data to the discriminator D to acquire the discrimination result (S111). Then, the tuning unit 22 calculates error information from the correct answer information of the training data and the discrimination result of the discriminator D (S112) and executes training of the discriminator D based on the error information (S113).

Here, the tuning unit 22 repeats S110 and the subsequent processes when the fine tuning is continued (S114: No) and terminates the training when the fine tuning is terminated (S114: Yes).

### Effects

As described above, the information processing device 10 may execute the generation of the machine learning model 15 adapted to the elements of an adversarial network that learns to deceive the discriminator. As a result, the information processing device 10 may improve the accuracy of pre-learning and may also improve the accuracy finally reached by the discriminator. In addition, since the unsupervised training data is used in the pre-learning, the information processing device 10 may improve the accuracy of pre-learning while decreasing the cost and labor for preparing the supervised training data. For example, the information processing device 10 may construct a network model that provides excellent problem information to generate a highly accurate model in the pre-learning of unsupervised learning for natural language processing.

### Second Embodiment

Meanwhile, in the machine learning model 15 using the adversarial RTD network according to the first embodiment, since the generator GA is specialized in prompting the discriminator D to make a mistake, the generator GA is also likely to be trained so as to completely break the original sentence and generate an arbitrary sentence whose sentence meaning makes sense totally differently such that the discriminator D is unable to differentiate. For example, the generator GA is also likely to be trained so as to output a fixed sentence no matter what input is made.

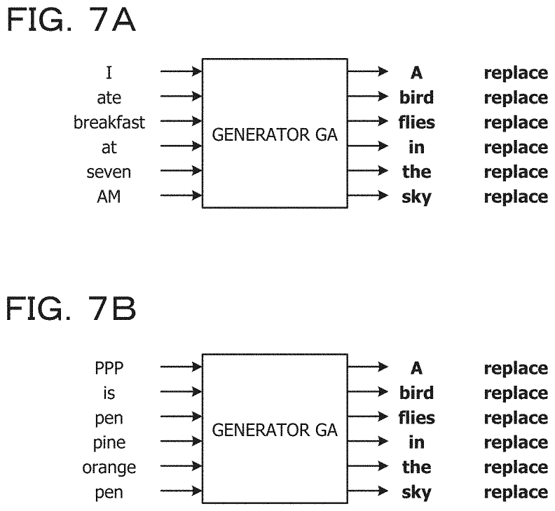

FIGS. 7A and 7B are diagrams illustrating points to be noted in the machine learning process according to the first embodiment. The generator GA will output the same for any input, as illustrated in FIGS. 7A and 7B, if the training specialized in prompting the discriminator D to make a mistake proceeds too much. For example, as illustrated in FIG. 7A, the discriminator D outputs “A bird flies in the sky” even if “I ate breakfast at seven AM” is input and outputs “A bird flies in the sky” even if “PPP is pen pine orange pen” is input. As a result, everything is treated as “replace” in the discriminator D, the training of the discriminator D does not proceed, and an appropriate problem for causing the discriminator D to perform machine learning is no longer acquired.

As described above, if a problem that is difficult for the discriminator D to differentiate is simply created, there is a likelihood that the generator GA will destroy the original sentence and an appropriate problem is no longer acquired. In regard to this situation, a second embodiment will describe an example of applying the cycle generative adversarial network (CycleGAN) used in image processing to natural language processing and causing the generator GA to learn so as to generate a problem that has consistency as a sentence but is difficult to differentiate.

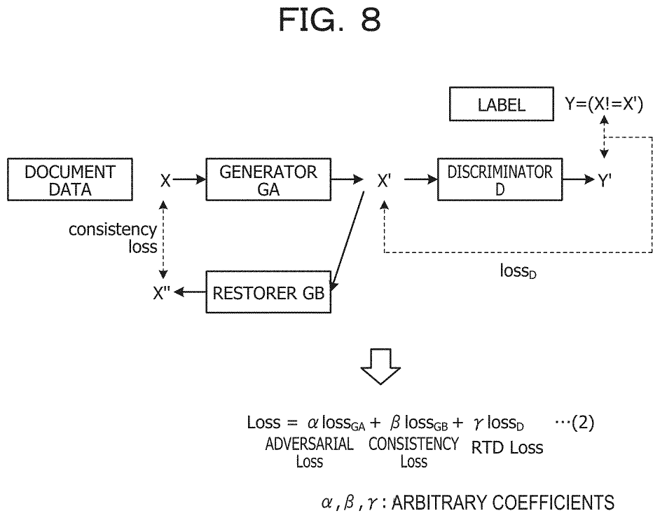

FIG. 8 is a diagram illustrating the pre-learning of a machine learning model 15 according to the second embodiment. As illustrated in FIG. 8, the machine learning model 15 according to the second embodiment includes a restorer GB in addition to the generator GA and the discriminator D described in the first embodiment. When the modified document data X′ generated by the generator GA in response to the input of the document data X is input, the restorer GB generates restored document data X″ obtained to restore the document data X.

For example, when the document data X “A bird flies in the sky” is input, the generator GA generates the modified document data X′ “A dog flies in the sky”. Then, when the modified document data X′ “A dog flies in the sky” is input, the restorer GB generates the restored document data X″ obtained to restore the document data X.

Here, in addition to the first error information and the second error information described in the first embodiment, a pre-learning unit 21 generates third error information based on the document data X and the restored document data X″, which is an example of third document data generated by the restorer GB. As this third error information, the pre-learning unit 21 generates “loss_{GB}” using a loss function for training the restorer GB such that the error between the document data X input to the generator GA and the restored document data restored by the restorer GB becomes smaller.

Then, the pre-learning unit 21 calculates a loss “Loss” of the entire machine learning model 15 as “Loss=αloss_{GA}+βloss_{GB}+γloss_{D}” as indicated by formula (2) in FIG. 8 and executes training to, for example, update various parameters of the generator GA, the restorer GB, and the discriminator D such that this “Loss” is minimized. For example, “αloss_{GA}” is a so-called adversarial loss, “βloss_{GB}” is a so-called consistency loss, and “γloss_{D}” is a so-called RTD loss. Note that α, β, and γ denote arbitrary coefficients.

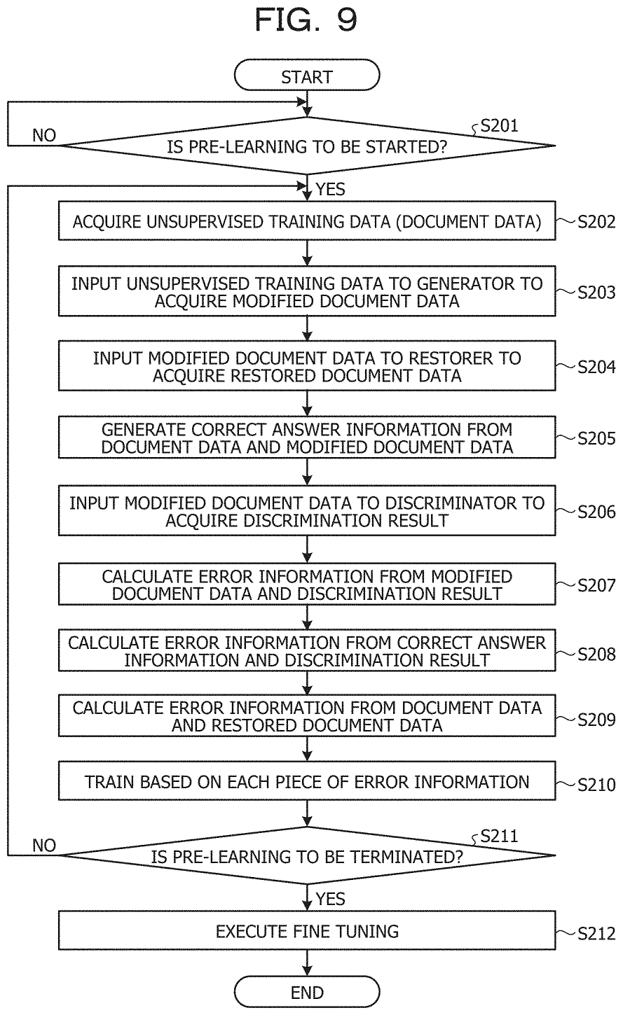

FIG. 9 is a flowchart illustrating a flow of a machine learning process according to the second embodiment. As illustrated in FIG. 9, when the pre-learning is started (S201: Yes), the pre-learning unit 21 acquires unsupervised training data (document data) (S202) and inputs the unsupervised training data to the generator GA to acquire modified document data (S203).

Subsequently, the pre-learning unit 21 inputs the modified document data to the restorer GB to acquire restored document data (S204). Then, the pre-learning unit 21 generates correct answer information from the document data and the modified document data (S205) and inputs the modified document data to the discriminator D to acquire discrimination result (S206).

Thereafter, the pre-learning unit 21 calculates error information from the modified document data and the discrimination result (S207), calculates error information from the correct answer information and the discrimination result (S208), and calculates error information from the document data and the restored document data (S209).

Then, the pre-learning unit 21 executes training based on each piece of the error information (S210) and, when the pre-learning is to be continued (S211: No), repeats S202 and the subsequent processes. On the other hand, when the pre-learning is to be terminated (S211: Yes), the fine tuning by a tuning unit 22 is executed (S212) as in the first embodiment.

As described above, an information processing device 10 according to the second embodiment executes training of the machine learning model 15 such that an adversarial problem against the discriminator D is generated while the consistency in the output of the generator GA is kept. As a result, the training of the generator GA proceeds such that the generator GA generates a problem that is more difficult for the discriminator D to differentiate as progressing in the latter half of the machine learning. The discriminator D has no choice but to take into account information on another plurality of words in the sentence data to differentiate. In addition, since the generator side does not have language processing capability, the generator GA is given training of “which word is a word having a similar meaning” and is not given the task of reading the sentence meaning. Accordingly, the information processing device 10 according to the second embodiment may generate a highly accurate model while reducing the occurrence of a state described with reference to FIG. 7 in which an appropriate problem is no longer acquired.

### Third Embodiment

While the embodiments have been described above, the embodiments may be carried out in a variety of different modes in addition to the embodiments described above.

### Numerical Values, etc.

The exemplary numerical values, the exemplary document data, the label names, the loss function, the number of words, and the like used in the embodiments described above are merely examples and may be arbitrarily modified. In addition, the flow of process described in each flowchart may be appropriately modified as long as no contradiction occurs.

Furthermore, in the above-described embodiments, the language processing using the document data has been described as an example, but the embodiments are not limited to this. For example, application to image processing using image data is also possible. In that case, for example, the generator GA generates converted image data in which any area in the image data is replaced with other image data, and the discriminator D discriminates whether each area in the converted image data falls under original or replace, and the restorer GB generates restored image data from the converted image data.

### System

Pieces of information including a processing procedure, a control procedure, a specific name, various types of data, and parameters described above or illustrated in the drawings may be arbitrarily modified unless otherwise noted.

In addition, each component of each device illustrated in the drawings is functionally conceptual and does not necessarily have to be physically configured as illustrated in the drawings. For example, specific forms of distribution and integration of the individual devices are not restricted to those illustrated in the drawings. For example, all or a part of the devices may be configured by being functionally or physically distributed or integrated in arbitrary units according to various types of loads, usage situations, or the like.

Furthermore, all or an arbitrary part of individual processing functions performed in each device may be implemented by a central processing unit (CPU) and a program analyzed and executed by the CPU, or may be implemented as hardware by wired logic.

### Hardware

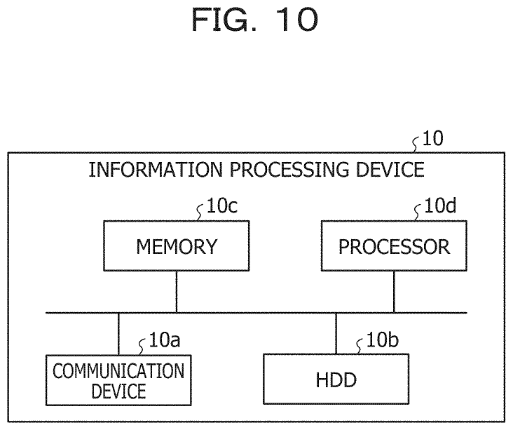

FIG. 10 is a diagram illustrating a hardware configuration example. As illustrated in FIG. 10, the information processing device 10 includes a communication device 10a, a hard disk drive (HDD) 10b, a memory 10c, and a processor 10d. Furthermore, the respective units illustrated in FIG. 10 are mutually connected by a bus or the like.

The communication device 10a is a network interface card or the like and communicates with another device. The HDD 10b stores programs and DBs for activating the functions illustrated in FIG. 2.

The processor 10d reads a program that executes processing similar to the processing of each processing unit illustrated in FIG. 2 from the HDD 10b or the like and loads the read program into the memory 10c, thereby activating a process that executes each function described with reference to FIG. 2 or the like. For example, this process executes a function similar to the function of each processing unit included in the information processing device 10. For example, the processor 10d reads, from the HDD 10b or the like, a program having functions similar to the functions of the pre-learning unit 21, the tuning unit 22, the operation execution unit 23, and the like. Then, the processor 10d executes a process for implementing processing similar to the processing of the pre-learning unit 21, the tuning unit 22, the operation execution unit 23, and the like.

As described above, the information processing device 10 is activated as an information processing device that executes a machine learning method by reading and executing a program. In addition, the information processing device 10 may also implement functions similar to the functions of the above-described embodiments by reading the above program from a recording medium by a medium reading device and executing the above program that has been read. Note that the program referred to in other embodiments is not limited to being executed by the information processing device 10. For example, the embodiments described above may be similarly applied also to a case where another computer or server executes the program or a case where these computer and server cooperatively execute the program.

This program may be distributed via a network such as the Internet. In addition, this program may be recorded in a computer-readable recording medium such as a hard disk, a flexible disk (FD), a compact disc read only memory (CD-ROM), a magneto-optical disk (MO), or a digital versatile disc (DVD), and may be executed by being read from the recording medium by a computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a process, the process comprising:
inputting training data to a machine learning model that includes a generator and a discriminator, the generator generating second input data in which a part of first input data is rewritten in response to an input of the first input data, the discriminator discriminating a rewritten portion in response to an input of the second input data generated by the generator;
generating correct answer information, based on the training data and an output result of the generator; and
executing training of the machine learning model by using first error information and second error information, the first error information being obtained based on the output result of the generator and a discrimination result of the discriminator, the second error information being obtained based on the discrimination result of the discriminator and the correct answer information.

2. The non-transitory computer-readable recording medium according to claim 1, wherein
the generator of the machine learning model
generates second document data in which some words in first document data are replaced with other words, in response to an input of the first document data, and
the discriminator of the machine learning model
executes discrimination as to whether each of words in the second document data is any of the words replaced by the generator, in response to an input of the second document data generated by the generator.

3. The non-transitory computer-readable recording medium according to claim 2, wherein
the machine learning model further includes
a restorer that generates third document data obtained to restore the first document data, in response to an input of the second document data generated by the generator, and
the process further comprises:
executing the training of the machine learning model, by using the first error information, the second error information, and third error information obtained based on the first document data and the third document data generated by the restorer.

4. The non-transitory computer-readable recording medium according to claim 3, the process further comprising:
generating, as the first error information, error information that uses a first loss function configured to train the generator such that the second document data is not discriminated by the discriminator;
generating, as the second error information, error information that uses a second loss function configured to train the discriminator such that an error between the discrimination result and the correct answer information becomes smaller; and
generating, as the third error information, error information that uses a third loss function configured to train the restorer such that an error between the first document data and the third document data becomes smaller.

5. The non-transitory computer-readable recording medium according to claim 3, the process further comprising:
executing the training of the machine learning model such that a total value of the first error information, the second error information, and the third error information is minimized.

6. The non-transitory computer-readable recording medium according to claim 1, the process further comprising:
inputting supervised training data, which includes the correct answer information, to the discriminator on which the training has been executed; and
executing training of the discriminator such that an error between the discrimination result output by the discriminator in response to an input of the supervised training data and the correct answer information is minimized.

7. The non-transitory computer-readable recording medium according to claim 6, the process further comprising:
inputting target document data, which is targeted for discrimination and contains a plurality of words, to the discriminator trained by using the supervised training data; and
discriminating words that have been altered among the plurality of words in the target document data, based on an output result of the discriminator.

8. A machine learning method, comprising:
inputting, by a computer, training data to a machine learning model that includes a generator and a discriminator, the generator generating second input data in which a part of first input data is rewritten in response to an input of the first input data, the discriminator discriminating a rewritten portion in response to an input of the second input data generated by the generator;
generating correct answer information, based on the training data and an output result of the generator; and
executing training of the machine learning model by using first error information and second error information, the first error information being obtained based on the output result of the generator and a discrimination result of the discriminator, the second error information being obtained based on the discrimination result of the discriminator and the correct answer information.

9. An information processing device, comprising:
a memory; and
a processor coupled to the memory and the processor configured to:
input training data to a machine learning model that includes a generator and a discriminator, the generator generating second input data in which a part of first input data is rewritten in response to an input of the first input data, the discriminator discriminating a rewritten portion in response to an input of the second input data generated by the generator;
generate correct answer information, based on the training data and an output result of the generator; and
execute training of the machine learning model by using first error information and second error information, the first error information being obtained based on the output result of the generator and a discrimination result of the discriminator, the second error information being obtained based on the discrimination result of the discriminator and the correct answer information.
